(19) United States
(12) Patent Application Publication
(10) Pub. No.: US 2023/0140097 A1
(43) Pub. Date: May 4, 2023

(54) Trench Cleaning Shovel Tool

(71) Applicant: Jose S. Hernandez, Missouri City, TX (US)

(72) Inventor: Jose S. Hernandez, Missouri City, TX (US)

(21) Appl. No.: 17/892,238

(22) Filed: Aug. 22, 2022

Related U.S. Application Data
(60) Provisional application No. 63/273,261, filed on Oct. 29, 2021.

(51) Int. Cl. A01B 1/02

(52) U.S. Cl. CPC A01B 1/022

(57) ABSTRACT

The present invention relates to a shovel device designed to clean trenches made by trenching machines. The shovel is also configured to easily dig inside trenches easily. The shovel tool includes an elongated handle and a shovel head attached to the elongated handle. The shovel head includes a raised aft end, a front edge, and a pair of opposing raised side surfaces. The shovel head having a concave shape raising upwards from the center towards the opposing raised side surfaces. The raised side surfaces and the raised aft end supports the soil and other materials placed in the shovel head and prevents same from falling out. The shovel head includes a width from about 2 inches to about 6 inches, thereby enabling easy operation of the tool within trenches made by trenching machines.

### CROSS-REFERENCE TO RELATED APPLICATION

The present application claims priority to, and the benefit of, U.S. Provisional Application No. 63/273,261, which was filed on Oct. 29, 2021 and is incorporated herein by reference in its entirety.

### FIELD OF THE INVENTION

The present invention relates generally to shovel heads and shovel handles. More specifically, the present invention relates to a novel trench cleaning shovel tool. The shovel tool has generally from about 2 inch to about 4 inch wide concave shaped shovel head connected to an extended handle. The concave shape enables the shovel head to easily accommodate soil and other materials without fear of falling. The shovel can be easily used within trenches made by a trenching machine without ruining walls of the trench. Accordingly, the present disclosure makes specific reference thereto. Nonetheless, it is to be appreciated that aspects of the present invention are also equally applicable to other like applications, devices, and methods of manufacture.

### BACKGROUND

By way of background, a shovel is a tool for digging, lifting, and moving bulk materials, such as for example, soil, coal, gravel, snow, sand, or ore. Shovels come in different shapes and styles and every shovel includes a head and a handle that extends from the head. The shape and style of shovels widely depend on intended use. Nonetheless, currently available shovel heads have a nearly flat construction. The flat construction of the shovel heads provide smooth edges and is useful for smoothing a surface such as a gravel surface, however, such shovel heads typically do not hold much dirt and therefore, force an operator to shovel considerable amounts to move dirt and debris.

Especially in cases where a trenching machine or a ditcher is used for creating a trench, shovels are used for digging and removing soil and other materials from a trench area. Generally, standard trenching machines are 4 inches in width and create trenches having generally a 4 inch width. Standard shovels used for digging through and cleaning trench areas are also generally 4 inches in width and therefore, damage and ruin the sides of the trench areas while performing digging. Further, an operator may not be able to dig efficiently inside the trench area using the 4 inch wide shovel. There is a need for an improved shovel that can be efficiently used in trench areas that provides less strain on the operator.

Currently available trench clean-out shovels provide muscle strain and are inefficient in removing loose soil left in the bottom of a trench. This results in an uneven surface for drainage or water pipes to rest on which may cause blockage in water drainage or disrupt flow of liquid therein. Individuals desire an improved trench clean-out shovel that effectively removes rubble, stones, and soil from trenches.

Therefore, there exists a long-felt need in the art for a trench clean-out shovel tool that effectively cleans trenches after a trenching machine has been applied. There is also a long-felt need in the art for a trench clean-out shovel tool that helps in providing a planar and flat surface for resting or installing water lines and drainage pipes. Additionally, there is a long-felt need in the art for a trench clean-out shovel tool that reduces effort and strain on an operator during use of the shovel. Moreover, there is a long-felt need in the art for an improved shovel that can be used for more pressure application and for removing a large amount of dirt, debris, stone, soil and more. Further, there is a long-felt need in the art for a trench clean-out shovel tool that enables an operator to easily work in a trench area without ruining the sides or edges of a trench. Furthermore, there is a long-felt need in the art for a shovel tool that quickly digs through a trench area. Finally, there is a long-felt need in the art for a trench clean-out shovel tool that saves time and effort when digging through trench areas for installation of pipes, lines, and cables.

The subject matter disclosed and claimed herein, in one embodiment thereof, comprises a trench clean-out shovel tool. The shovel tool is used for easily and effectively cleaning trenches after a trenching machine has been operated to dig a trench and enables operators to efficiently install pipes into the trenches. The tool further comprises a telescoping handle having a top end and a bottom end, a shovel head attached to said bottom end through an arcuate connector, the shovel head is substantially concave, raising from a center towards raised side edges wherein the shovel head extends from a front edge to an aft end, the arcuate connector is integrally molded at said aft end, wherein the front edge defines a trench surface penetrating edge. The raised side edges and the aft end provide support to soil, stones, dirt, or any other material placed in the shovel head and prevents same from falling while the shovel is lifted, wherein the width of the head measured across the raised edges is up to three inches.

In this manner, the trench cleaning shovel tool of the present invention accomplishes all of the forgoing objectives and provides users with an improved shovel used for helping clean trenches made by a trenching machine. The tool enables users to effectively and efficiently install pipes, lines, and cables without digging out unnecessary additional dirt via the shovel. The shovel saves time and effort when digging through trench areas and reduces strain and effort of a user operating the tool.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trench clean-out shovel tool. The shovel tool further comprising a telescoping handle having a top end and a bottom end, a shovel head attached to said bottom end via an arcuate connector, the shovel head is substantially concave with raised side edges wherein the shovel head extends from a front edge to an aft end, the arcuate connector is integrally molded at said aft end, the front edge is substantially concave in shape and defines a trench surface penetrating edge, the raised side edges and the aft end provide support to soil, stones, dirt, or any other material placed in the shovel head and prevents same from falling while the shovel is lifted, wherein the width of the head measured across the raised edges is up to three inches.

In yet another embodiment, a shovel device includes an aft end configured to receive a foot of a user for penetrating a front edge of a shovel head into a trench surface.

In yet another embodiment, the shovel includes a one-piece structure, and the handle is detachable from the shovel head.

In yet another embodiment, the shovel device for cleaning trenches made by a trenching machine is disclosed. The shovel device includes the shovel head operatively attached to a handle via an arcuate connecting member, wherein the arcuate connecting member is molded at an aft end of the shovel head, a substantially concave shape formed in the shovel head with a pair of opposing raised edges extending from a front edge to said aft end, the handle is fixed at an angle from about thirty degrees to about fifty degrees relative to the shovel head allowing easy movement of the shovel head for cleaning trenches wherein the shovel head can be made of 14-gauge steel for supporting a heavy load on the shovel head.

In yet another embodiment, a cleaning master trench shovel is disclosed. The cleaning master trench shovel includes a handle, a shovel head attached to the handle, a foot bar for accommodating a foot of an operator operating the tool for cleaning and digging a trench, the shovel head is substantially concave in shape with raised side edges, a concave front edge and a planar aft end wherein the raised side edges and aft end securely holds the soil, stones, gravel, dirt, or any other material placed on the shovel head while the shovel is lifted by the operator.

In yet another embodiment, the handle is made from a material selected from a steel, a metal, a plastic, a wood or a fiberglass.

In yet another embodiment, the shovel head includes a width in the range of 2 to 6 inches, and the shovel head is made from galvanized 14-gauge steel.

In yet another embodiment, the handle is telescoping and includes a maximum length from about 50 inches to about 70 inches.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the standalone trench clean-out shovel tool of the present invention in accordance with the disclosed architecture;

FIG. 2 illustrates a side view of standalone trench clean-out shovel tool of the present invention showing the height and angle of the handle relative to the ground in accordance with the disclosed architecture;

FIG. 3 illustrates a perspective view of an operator using the trench clean-out shovel tool of the present invention for operating in a trench in accordance with the disclosed architecture;

FIG. 4 illustrates a perspective view of the operator using the trench clean-out shovel tool of the present invention from outside the trench in accordance with the disclosed architecture; and

FIG. 5 illustrates a perspective view showing an operator using another potential embodiment of the cleaning master trench shovel of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a trench clean-out shovel tool that effectively cleans trenches after a trenching machine has been operated and applied to digging a trench. There is also a long-felt need in the art for a trench clean-out shovel tool that helps in providing a planar and flat surface for resting or installing water lines and drainage pipes. Additionally, there is a long-felt need in the art for a trench clean-out shovel tool that reduces effort and strain on an operator during use of the shovel. Moreover, there is a long-felt need in the art for an improved shovel that can be used for more pressure application and for removing a large amount of dirt, debris, stones, gravel, soil and more. Further, there is a long-felt need in the art for a trench clean-out shovel tool that enables an operator to easily work in a trench area without ruining sides or edges of a trench. Furthermore, there is a long-felt need in the art for a shovel tool that quickly digs through trench areas. Finally, there is a long-felt need in the art for a trench clean-out shovel tool that saves time and effort when digging through trench areas for installation of pipes, lines, and cables.

The present invention, in one exemplary embodiment, is a novel shovel device for cleaning trenches left by a trenching machine. The shovel device includes a shovel head operatively attached to a handle via an arcuate connecting member, wherein the arcuate connecting member is molded at an aft end of the shovel head, a substantially concave shape formed in the shovel head with a pair of opposing raised edges extending from a front edge to said aft end, the handle is fixed at an angle from about thirty degrees to about fifty degrees relative to the shovel head allowing easy movement of the shovel head for cleaning trenches wherein the shovel head can be made of 14-gauge steel for supporting a heavy load on the head. The shovel head is from about 2 inches to about 6 inches in width and from about 8 inches to about 10 inches in length, thereby making it easy for an operator to use the shovel inside a trench made by the trenching machine.

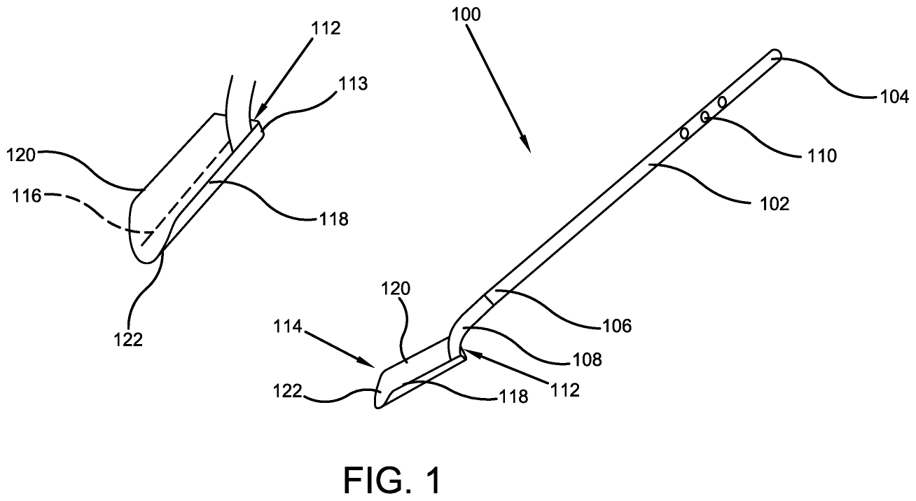

Referring initially to the drawings, FIG. 1 illustrates a perspective view of one potential embodiment of the standalone trench clean-out shovel tool of the present invention in accordance with the disclosed architecture. The trench clean-out shovel tool 100 of the present invention is an improved and novel shovel tool designed specifically for use in digging out and cleaning trench areas dug by a trenching machine. The shovel tool 100 is made from professional grade steel and enables an operator of the tool 100 to dig and clean trench areas faster and easier. Further, the tool 100 can be used by both pushing and pulling the tool 100 for effective operation.

More specifically, the trench clean-out shovel tool 100 includes a telescopic handle 102 having a top end 104 and a bottom end 106. The telescopic handle 102 can be made of steel, wood, plastic, fiberglass, or other material. The handle 102 includes a plurality of telescoping slots 110 for extending or retracting to adjust a length of the tool 100. A curved or arcuate connector 108 is permanently fastened, using welding, mechanical fastening, or any other technique, to the bottom end 106 of the handle 102 wherein the opposite end of the connector 108 is molded to the aft end 112 of the shovel head 114. The aft end 112 includes a raised planar surface 113. The shovel head 114 is preferably a concave shaped curvature including a longitudinal central axis line 116. The shovel head 114 includes terminal side edges 118, 120. A front edge 122 of the head 114 is substantially U-shaped or concave shaped. The length of the shovel head 114 is greatest along the longitudinal central axis line 116 relative to the length of the side edges 118, 120. Further, the side edges 118, 120 are raised in order to keep the soil, stones, and dirt in place on the shovel head 114 when the shovel 100 is raised out of the trench.

A width of the shovel head 114 is measured across the side edges 118, 120 and is preferably from about 2 inches to about 6 inches. Further, the length of the head 114 measured from the front edge 122 to the aft end 112 and is from about 8 inches to about 12 inches. It should be noted that the width of the shovel head 114 can be customized to be less than 3 inches as per the preference of manufacturers and operators. The shovel head 114 and the arcuate connector 108 can be formed from one piece of thick 14-gauge carbon steel that provides the durability and hardness needed to prevent bending or breaking of the head 114 when striking or penetrating hard shale, rocks, and roots in the trench. The handle 102 measures generally from about 50 inches to about 70 inches in total length which enables less strain on the operator while performing digging and cleaning operations in a trench.

The arcuate connector 108 can also be used as a step for secure contact with a foot of an operator to push the shovel head 114 downward into the trench for digging. An operator can also place a foot on the planar surface 113 of the aft end 112 of the head 114 for pushing the front edge 122 of the shovel head 114 into the bottom of the trench for digging.

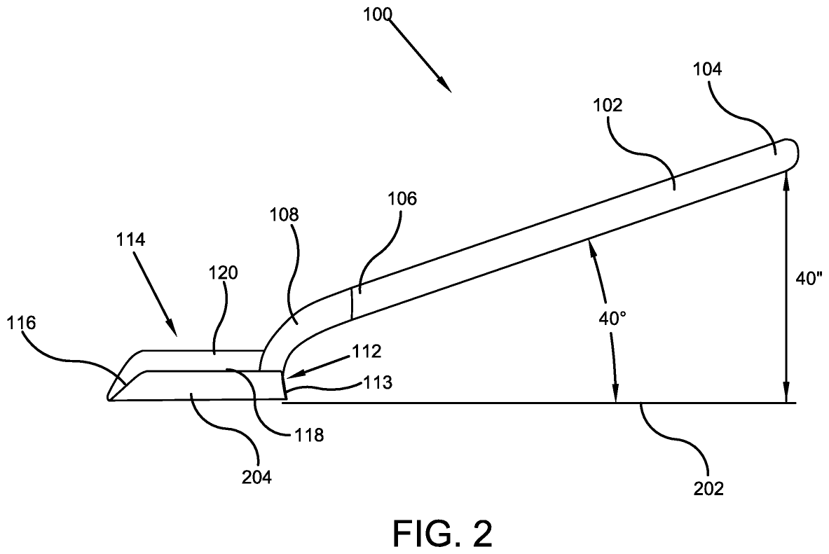

FIG. 2 illustrates a side view of standalone trench clean-out shovel tool of the present invention showing the height and angle of the handle relative to the ground in accordance with the disclosed architecture. As illustrated, when the shovel tool 100 is placed on the ground 202 such that the bottom surface 204 of the shovel head 114 is placed flat on the ground 202 (i.e. central axis 116 contiguous with a bottom of the trench), then, the maximum vertical height of the top end 104 of the handle 102 is from about 30 inches to about 50 inches from the ground 202. The handle 102 is designed such that length of the handle 102 is configured to provide less strain while digging and cleaning a trench area created by a trench machine. Further, the length of the handle 102 enables an operator to both pull and push the shovel 100 easily during use.

The angle made by the handle 102 relative to the ground 202 is from about thirty degrees to about fifty degrees which prevents excessive bending of an operator while using the shovel tool 100.

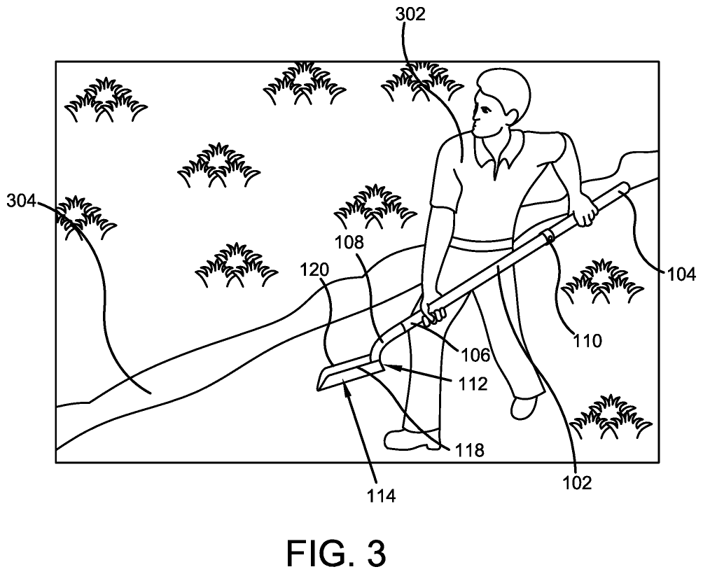

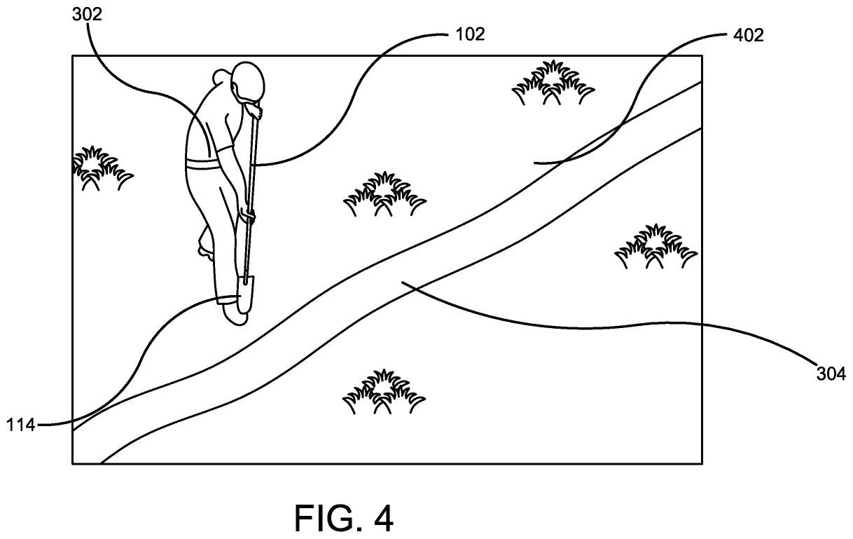

FIG. 3 illustrates a perspective view of an operator using the trench clean-out shovel tool of the present invention for operating in a trench in accordance with the disclosed architecture. The operator 302 can enter into a trench 304 or alternatively can use the cleaning master trench shovel 100 from outside the trench area 304 (as shown in FIG. 4) for digging and cleaning the trench 304 made by a trench machine. The handle 102 can be adjusted in length as per the requirements or preferences of the operator 302 and the shovel 100, having soil and other material placed on the shovel head 114, can be lifted to clean the trench 304. The concave shape along with side edges and aft end enables the soil and other material to be easily lifted for effective cleaning of the trench. Further, the operator 302 can apply a foot on an aft end and arcuate connector for digging (i.e. pushing) the shovel head 114 into the trench surface.

It should be appreciated that the width of the head 114 is designed such that the walls of the trench 304 are not broken or damaged while the shovel 100 is used by the operator 302.

FIG. 4 illustrates a perspective view of the operator using the trench clean-out shovel tool of the present invention from outside the trench in accordance with the disclosed architecture. As illustrated, the operator 302 in the present embodiment operates the shovel 100 in the trench area 304 by standing outside the trench area 304 such as on the ground 402.

The handle 102 of the tool 100 can be extended thereby allowing the shovel head 114 to reach the surface of the trench area 304. Further, the head 114 can be easily used for cleaning out ground areas dug by a trenching machine. The head 114 holds more soil and dirt than conventional trench shovels and thus saves time and effort when digging through trench areas.

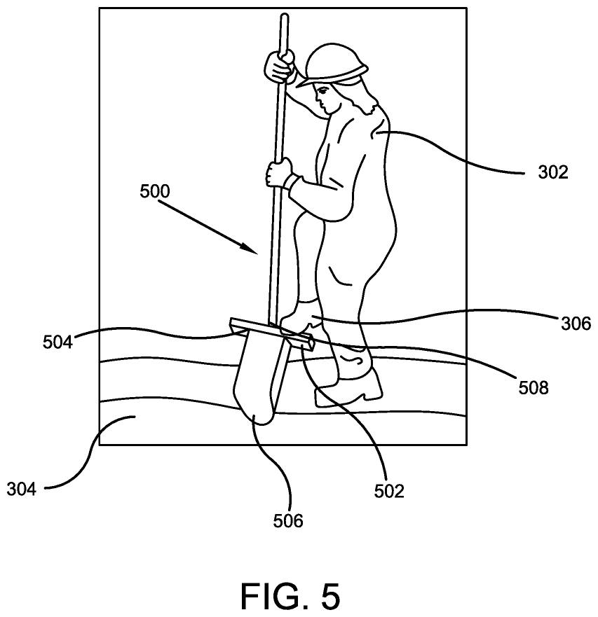

FIG. 5 illustrates a perspective view showing an operator using another potential embodiment of the cleaning master trench shovel of the present invention in accordance with the disclosed architecture. In the present embodiment, the shovel tool 500 includes a foot step bar 502 welded to the aft end 504 of the head 506. The arcuate connector 508 is also molded to the aft end 504 in the same manner as shown in FIG. 1. The operator 302, while using the tool 500, can put a foot 306 on the foot step bar 502 thereby allowing the tool 500 to easily perform digging in the trench area 304 and also helps in lateral movement of the head [114] 506 along the surface of the trench area 304.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trench clean-out shovel”, “shovel tool”, “tool”, “shovel”, and “cleaning master trench shovel” are interchangeable and refer to the trench clean-out shovel tool 100,500 of the present invention.

Notwithstanding the forgoing, the trench clean-out shovel tool 100,500 of the present invention can be of any suitable size and configuration as is known in the art without affecting the overall concept of the invention, provided that it accomplishes the above-stated objectives. One of ordinary skill in the art will appreciate that the trench clean-out shovel tool 100,500 as shown in the FIGS. are for illustrative purposes only, and that many other sizes and shapes of the trench clean-out shovel tool 100 are well within the scope of the present disclosure. Although the dimensions of the trench clean-out shovel tool 100,500 are important design parameters for user convenience, the trench clean-out shovel tool 100,500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shovel tool for cleaning out a trench, the shovel tool comprising:
a telescopic handle;
a shovel head; and
an arcuate connector connecting said handle and said shovel head;
wherein said telescopic handle includes a plurality of telescoping slots to adjust a length of said telescopic handle;
wherein said shovel head includes a concave shaped curvature having a longitudinal central axis, terminal side edges, and a generally U-shaped front edge;
wherein a length of said shovel head is greatest along said longitudinal central axis relative to a length of said side edges;
wherein said side edges are raised along opposing sides of said shovel head; and
further wherein said shovel head includes a width measured between said side edges from about 2 inches to about 6 inches.

2. The shovel tool of claim 1, wherein said shovel head includes a length from about 8 inches to about 12 inches between an aft end and said front edge of said shovel head.

3. The shovel tool of claim 2, wherein said width of said shovel head is from about 2 inches to about 4 inches.

4. The shovel tool of claim 2, wherein said handle includes a material selected from a group consisting of a steel and a fiberglass.

5. The shovel tool of claim 4, wherein said shovel head and said arcuate connector are one piece comprising 14-gauge carbon steel.

6. The shovel tool of claim 5, wherein said handle includes a length from about 50 inches to about 70 inches.

7. The shovel tool of claim 6, wherein said aft end is raised along a back of said shovel head and includes a planar surface for contact with a foot of an operator to push said shovel head downward.

8. The shovel tool of claim 7, wherein when said longitudinal central axis of said shovel head is contiguous with a bottom of the trench, a vertical height of a top end of said handle is from about 30 inches to about 50 inches from the bottom of the trench.

9. The shovel tool of claim 8, wherein when said longitudinal central axis of said shovel head is contiguous with a bottom of the trench, an angle between said handle and the bottom of the trench is from about 30 degrees to about 50 degrees.

10. A shovel tool for cleaning out a trench, the shovel tool comprising:
a handle;
a shovel head; and
an arcuate connector connecting said handle and said shovel head;
wherein said shovel head includes a concave shaped curvature having a longitudinal central axis, terminal side edges, and a generally U-shaped front edge;
wherein a length of said shovel head is greatest along said longitudinal central axis relative to a length of said side edges;
wherein said side edges are raised along opposing sides of said shovel head;
wherein said shovel head includes a width measured between said side edges from about 2 inches to about 6 inches;
wherein said shovel head includes a length from about 8 inches to about 12 inches between an aft end and said front edge of said shovel head; and
further wherein said aft end is raised along a back of said shovel head and includes a planar surface for contact with a foot of an operator to push said shovel head downward.

11. The shovel tool of claim 10, wherein said width of said shovel head is from about 2 inches to about 4 inches.

12. The shovel tool of claim 10, wherein said handle includes a length from about 50 inches to about 70 inches.

13. The shovel tool of claim 10, wherein when said longitudinal central axis of said shovel head is contiguous with a bottom of the trench, a vertical height of a top end of said handle is from about 30 inches to about 50 inches from the bottom of the trench.

14. The shovel tool of claim 13, wherein when said longitudinal central axis of said shovel head is contiguous with a bottom of the trench, an angle between said handle and the bottom of the trench is from about 30 degrees to about 50 degrees.

15. A trench clean-out shovel tool comprising:
a handle;
a shovel head; and
an arcuate connector connecting said handle and said shovel head;
wherein said shovel head includes a concave shaped curvature having a longitudinal central axis, terminal side edges, and a generally U-shaped front edge;
wherein a length of said shovel head is greatest along said longitudinal central axis relative to a length of said side edges;
wherein said side edges are raised along opposing sides of said shovel head;
wherein said shovel head includes a width measured between said side edges from about 2 inches to about 6 inches;
wherein said shovel head includes a length from about 8 inches to about 12 inches between an aft end and said front edge of said shovel head; and
further wherein said aft end includes a foot step bar for selective contact with a foot of an operator to push said shovel head downward.

16. The shovel tool of claim 15, wherein said width of said shovel head is from about 2 inches to about 4 inches.

17. The shovel tool of claim 15, wherein said handle includes a length from about 50 inches to about 70 inches.

18. The shovel tool of claim 15, wherein when said longitudinal central axis of said shovel head is contiguous with a bottom of the trench, a vertical height of a top end of said handle is from about 30 inches to about 50 inches from the bottom of the trench.

19. The shovel tool of claim 15, wherein when said longitudinal central axis of said shovel head is contiguous with a bottom of the trench, an angle between said handle and the bottom of the trench is from about 30 degrees to about 50 degrees.

20. The shovel tool of claim 19, wherein said shovel head and said arcuate connector are one piece comprising 14-gauge carbon steel.
